(19) United States
(12) Patent Application Publication
(10) Pub. No.: US 2020/0019249 A1
(43) Pub. Date: Jan. 16, 2020

(54) ROBOT SYSTEM AND CONTROL METHOD THEREOF

(71) Applicant: LG ELECTRONICS INC., Seoul (KR)

(72) Inventor: Won Hee Lee, Seoul (KR)

(73) Assignee: LG ELECTRONICS INC., Seoul (KR)

(21) Appl. No.: 16/567,854

(22) Filed: Sep. 11, 2019

(30) Foreign Application Priority Data
Jul. 25, 2019 (KR) 10-2019-0090232

(51) Int. Cl. G06F 3/03; G06F 3/01; G06F 3/14; B25J 9/16; A63F 13/213

(52) U.S. Cl. CPC G06F 3/03; G06F 3/011; A63F 2300/8082; B25J 9/1697; A63F 13/213; G06F 3/14

(57) ABSTRACT

A robot system and a method of controlling the robot system are provided. According to an embodiment, the robot system includes a robot, a server that stores information on a motion of the robot, and a terminal that communicates with the robot and the server, receives a motion of the robot from the robot, receives a stored character motion from the server, and displays a character motion corresponding to the robot as an image. The robot system may transmit and receive a wireless signal over a mobile communication network based on 5G communication technologies.

### CROSS-REFERENCE TO RELATED APPLICATION

This present application claims benefit of priority to Korean Patent Application No. 10-2019-0090232, entitled “Robot System and Control Method Thereof” and filed on Jul. 25, 2019, in the Korean Intellectual Property Office, the entire disclosure of which is incorporated herein by reference.

### BACKGROUND

### 1. Technical Field

Embodiments of the present disclosure relate to a robot system and a method for controlling the robot system and, more particularly, to a robot system for implementing virtual reality and a method for controlling the robot system.

### 2. Description of Related Art

The description in this section merely provides background information on embodiments of the present disclosure, and does not constitute prior art.

Active research on virtual reality technology is being undertaken, and a variety of virtual reality content is currently being provided. Application of virtual reality technology is expanding to include various fields, such as games, robots, music, and medical fields.

Rather than merely passively enjoying immersive virtual reality images, users want to actively participate in a virtual environment. For example, when playing a virtual reality game, a user may want to modify a virtual character's motion in a virtual reality world in such a manner that the character moves as he or she wants.

For this reason, a user-friendly character motion input device is required which allows a user to easily modify character motion in a virtual reality world. When inputting motion data for generating a virtual character's motion with a computer, typical input devices such as a keyboard, a mouse, and a joystick are used. However, conventional input devices are inconvenient to use, and using such input devices, it is not easy to input motion data for creating complex character motions.

In addition, in order to improve convenience in use, it is desirable for a character motion input device to operate in a contactless manner. This is because contactless type input devices can reduce fatigue and stress of the user. Therefore, a system that includes a movable robot as a character motion input device, and which moves the robot in a contactless manner, is required.

U.S. Pat. No. 8,734,242 discloses a system including an action figurine provided with a serial number with which the user can access an online game and utilize virtual items.

Korean Patent Registration No. 10-1234111 discloses a contactless input interfacing device and method capable of transmitting an input signal to a system using only movement of a finger or a hand.

However, the above documents do not disclose a technology for moving a robot in a contactless manner so as to input a motion of a virtual character.

### SUMMARY OF THE INVENTION

An aspect of the present disclosure is to provide a method of using a movable robot as a motion input device in order to generate a motion of a character (hereinafter referred to as a character motion) existing in a virtual environment.

According to the aspect, the robot used to input the character motion may be operated in a contactless manner.

According to the aspect, a proximity sensor may be used to enable contactless operation of the robot.

Aspects of the present disclosure are not limited to those described above, and other aspects not mentioned may be more clearly understood from the following description by a person skilled in the art to which the present disclosure pertains.

According to an embodiment of the present disclosure, a user may move a body part of a robot to generate a motion of a character in a virtual environment.

A robot system according to an embodiment of the present disclosure may include a robot, a server that stores information on a motion of the robot (hereinafter referred to as a robot motion), and a terminal that communicates with the robot and the server, receives a robot motion from the robot, receives a character motion from the server, and displays the character motion corresponding to the robot motion as an image.

The robot may include actuators that move respective body parts of the robot, proximity sensors provided in the respective body parts of the robot and configured to detect a body part of a user when the body part of the user is present within a predetermined range around at least one of the proximity sensors, a controller connected with the actuators and the proximity sensors and configured to command the actuators to operate when receiving a signal indicating that the body part of the user is present within the predetermined range from at least one of the proximity sensors, and a communication unit connected with the controller.

In a character motion input mode, the robot may generate and transmit a plurality of robot motions to the terminal, the terminal may transmit the robot motions to the server, and the server may combine the received robot motions to generate character motions.

In a character motion playback mode, the robot may transmit the character motions to the terminal, and the terminal may display the character motion as an image.

In the character motion playback mode, the robot may transmit the robot motions to the terminal, the terminal may transmit the robot motions to the server, the server may modify the character motions on the basis of the received robot motions and transmit the modified character motions to the terminal, and the terminal may display the modified character motions as an image.

A method of controlling a robot system according to another embodiment of the present disclosure may include connecting a terminal with a robot and a server, checking whether the robot system is in a character motion input mode, generating, by the server, a character motion when the robot system is in the character motion input mode, and displaying, by the terminal, the character motion as an image.

The connecting of the terminal with the robot and the server may include communicably connecting the robot with the terminal; recognizing, by the terminal, a MAC address and an identifier of the robot, communicably connecting the terminal with the server; and selecting, by the terminal, an item of content provided by the terminal.

The generating of the character motion may include generating and transmitting, by the robot, a plurality of robot motions, generating, by the server, the character motion by combining the plurality of robot motions received from the robot, and storing, by the server, the generated character motion.

The displaying of the character motion may include transmitting, by the server, the character motion to the terminal, displaying, by the terminal, the character motion as an image, and modifying the character motion.

The modifying of the character motion may include transmitting, by the robot, the robot motion, transmitting, by the terminal, the robot motion to the server, modifying, by the server, the character motion on the basis of the received robot motion, storing, by the server, the modified character motion, transmitting, by the server, the modified character motion to the terminal, and displaying, by the terminal, the modified character motion as an image.

According to embodiments of the present disclosure, the user may input a motion by using a three-dimensional robot. Accordingly, the level of immersion in a game or in display content may be improved.

According to the embodiments of the present disclosure, the user may use a robot equipped with proximity sensors. Accordingly, the user may conveniently generate a character motion.

According to the embodiments of the present disclosure, since the server may generate a character motion on the basis of a robot motion using an artificial intelligence (AI) model learning algorithm, diverse and complex character motions may be generated.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating a robot system according to an embodiment of the present disclosure;

FIG. 2 is a diagram illustrating a character according to an embodiment of the present disclosure;

FIG. 3 is a diagram illustrating a character according to another embodiment of the present disclosure;

FIG. 4 is a diagram illustrating a structure of a robot according to an embodiment of the present disclosure;

FIGS. 5A to 5D are diagrams illustrating a motion of a robot according to an embodiment of the present disclosure;

FIGS. 6A to 6B are diagrams illustrating a motion of a robot according to another embodiment of the present disclosure;

FIG. 7 is a diagram illustrating a method of controlling a robot system according to an embodiment of the present disclosure;

FIG. 8 is a diagram illustrating a process in which a terminal is connected to a robot and a server, according to an embodiment of the present disclosure;

FIG. 9 is a diagram illustrating a process in which a server generates a character motion, according to an embodiment of the present disclosure;

FIG. 10 is a diagram illustrating a process in which a terminal device displays an image showing a character motion, according to an embodiment of the present disclosure;

FIG. 11 is a diagram illustrating a process of modifying a character motion, according to an embodiment of the present disclosure;

FIG. 12 is a diagram illustrating an artificial intelligence (AI) device according to an embodiment of the present disclosure;

FIG. 13 is a diagram illustrating an AI server according to an embodiment of the present disclosure; and

FIG. 14 is a diagram illustrating an AI system according to an embodiment of the present disclosure.

### DETAILED DESCRIPTION

Hereinbelow, embodiments will be described in greater detail with reference to the accompanying drawings.

Advantages and features of the present disclosure and methods for achieving them will become apparent from the descriptions of aspects herein below with reference to the accompanying drawings. However, the present disclosure is not limited to the aspects disclosed herein but may be implemented in various different forms. The aspects are provided to make the description of the present disclosure thorough and to fully convey the scope of the present disclosure to those skilled in the art. It is to be noted that the scope of the present disclosure is defined only by the claims.

Although the terms first, second, third, and the like, may be used herein to describe various elements, components, regions, layers, and/or sections, these elements, components, regions, layers, and/or sections should not be limited by these terms. Furthermore, these terms such as “first,” “second,” and other numerical terms, are used only to distinguish one element from another element.

In the description of the embodiment, in the case in which it is described as being formed on “on” or “under” of each element, “on” or “under” includes two elements directly contacting each other or one or more other elements being indirectly formed between the two elements. In addition, when expressed as “on” or “under”, it may include not only upwards but also downwards with respect to one element.

Further, it is also to be understood that the relational terms such as “top/upper portion/above” and “bottom/lower portion/ below” as used below do not necessarily imply any physical or logical relationship or order between such entities or elements, but may be used to distinguish one entity or element from another entity or element.

Embodiments of the present disclosure may relate to artificial intelligence, a robot, self-driving, and extended reality. These will be described first below.

Artificial intelligence refers to a field of studying artificial intelligence or a methodology for creating the same. Moreover, machine learning refers to a field of defining various problems dealing in an artificial intelligence field and studying methodologies for solving the same.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating a model parameter, and an activation function for generating an output value.

The ANN may include an input layer, an output layer, and may selectively include one or more hidden layers. Each layer includes one or more neurons, and the artificial neural network may include synapses that connect the neurons to one another. In an ANN, each neuron may output a function value of an activation function with respect to the input signals inputted through a synapse, weight, and bias.

Model parameters refer to parameters determined through learning, and may include weights of synapse connections, biases of neurons, and the like. Moreover, hyperparameters refer to parameters which are set before learning in a machine learning algorithm, and include a learning rate, a number of iterations, a mini-batch size, an initialization function, and the like.

The objective of training an ANN is to determine model parameters for significantly reducing a loss function. The loss function may be used as an indicator for determining an optimal model parameter during the learning process of an artificial neural network.

Machine learning may be classified into supervised learning, unsupervised learning, and reinforcement learning, depending on the learning method.

Supervised learning may refer to a method for training an artificial neural network with training data that has been given a label. In addition, the label may refer to a target answer (or a result value) to be guessed by the artificial neural network when the training data is inputted to the artificial neural network. Unsupervised learning may refer to a method for training an artificial neural network using training data that has not been given a label. Reinforcement learning may refer to a learning method for training an agent defined within an environment to select an action or an action order for maximizing cumulative rewards in each state.

Machine learning of an artificial neural network implemented as a deep neural network (DNN) including a plurality of hidden layers may be referred to as deep learning, and the deep learning is one machine learning technique. Hereinafter, the meaning of machine learning includes deep learning.

A robot may refer to a machine which automatically handles a given task by its own ability, or which operates autonomously. In particular, a robot having a function of recognizing an environment and performing an operation according to its own judgment may be referred to as an intelligent robot.

Robots may be classified into industrial, medical, household, and military robots, according to the purpose or field of use.

A robot may include a driving unit including an actuator or a motor in order to perform various physical operations, such as moving joints of the robot. Moreover, a movable robot may include, for example, a wheel, a brake, and a propeller in the driving unit thereof, and through the driving unit may thus be capable of traveling on the ground or flying in the air

Self-driving refers to a technology in which driving is performed autonomously, and a self-driving vehicle refers to a vehicle capable of driving without manipulation of a user or with minimal manipulation of a user.

For example, self-driving may include a technology in which a driving lane is maintained, a technology such as adaptive cruise control in which a speed is automatically adjusted, a technology in which a vehicle automatically drives along a defined route, and a technology in which a route is automatically set when a destination is set.

A vehicle includes a vehicle having only an internal combustion engine, a hybrid vehicle having both an internal combustion engine and an electric motor, and an electric vehicle having only an electric motor, and may include not only an automobile but also a train and a motorcycle.

In this case, a self-driving vehicle may be considered as a robot with a self-driving function.

Extended reality (XR) collectively refers to virtual reality (VR), augmented reality (AR), and mixed reality (MR). VR technology provides objects or backgrounds of the real world only in the form of CG images, AR technology provides virtual CG images overlaid on the physical object images, and MR technology employs computer graphics technology to mix and merge virtual objects with the real world.

MR technology is similar to AR technology in that both technologies involve physical objects being displayed together with virtual objects. However, while virtual objects supplement physical objects in AR, virtual and physical objects co-exist as equivalents in MR.

XR technology may be applied to a head-mounted display (HMD), a head-up display (HUD), a mobile phone, a tablet PC, a laptop computer, a desktop computer, a TV, digital signage, and the like. A device employing XR technology may be referred to as an XR device.

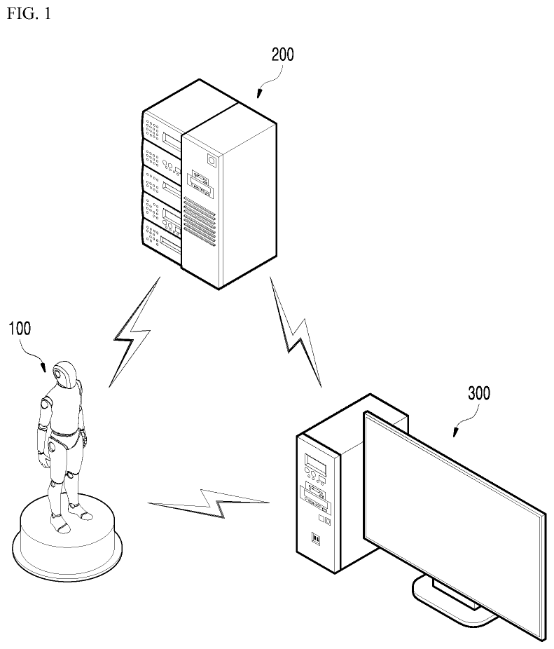

FIG. 1 is a diagram illustrating a robot system according to an embodiment of the present disclosure. In the robot system, a user may input a motion of a robot 100 (hereinafter referred to as a robot motion), and the robot motion is displayed as a motion of a character (hereinafter referred to as a character motion) on a terminal 300. Here, the user generates a robot motion by moving the robot 100, a character motion is generated on the basis of the robot motion, and the generated character motion is displayed on the terminal 300. The robot 100 exists in the real world, and the character exists in virtual reality. The user may watch the character displayed on the terminal 300.

The robot system includes the robot 100, a server 200, and the terminal 300.

The character motion is generated be means of the user moving a specific part of the robot 100. The robot 100 may be similar in body shape to a human being in terms of having arms, legs, and a head. The robot 100 is composed of a plurality of body parts, and joints that join the body parts.

The server 200 may store information on motions of the robot 100. The server 200 may generate a character motion to be displayed on the terminal 300 on the basis of the robot motion transmitted from the terminal 300.

The terminal 300 can communicate with each of the robot 100 and the server 200. The terminal 300 receives a robot motion from the robot 100, receives a character motion from the server 200, and displays a character corresponding to the robot 100 as an image.

The terminal 300 may display a moving character as an image. Examples of the terminal 300 include a smart phone, a laptop computer, a desktop computer, and a tablet PC.

The robot 100 and the server 200 are capable of communicating with each other. For example, the robot 100 may download a required software program from the server 200, and may regularly update the software program.

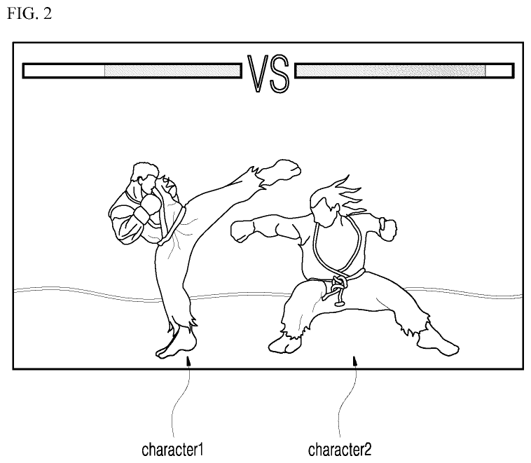

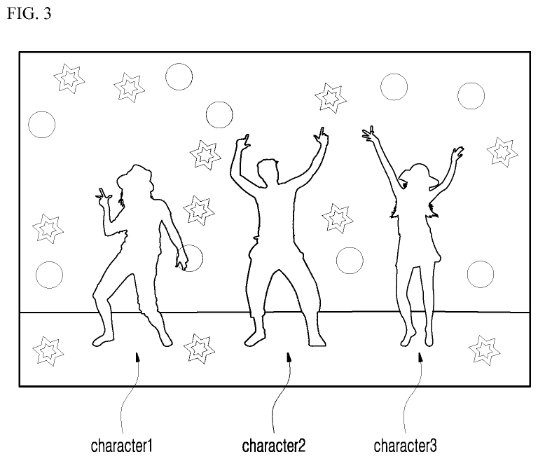

FIG. 2 is a diagram illustrating a character according to an embodiment of the present disclosure. FIG. 3 is a diagram illustrating a character according to another embodiment of the present disclosure.

Referring to FIGS. 2 and 3, a plurality of characters may be displayed on the terminal 300. Here, each different character may correspond to a different robot 100. That is, the robot system may include a plurality of robots 100 and a plurality of characters. Motions of different robots 100 are transmitted to the server 200, and combined in the server 200 so as to construct a plurality of characters to be displayed in the same virtual environment. The motions of the plurality of characters simultaneously displayed on the terminal 300 may be different from each other.

In the robot system according to an embodiment, one character exists in a virtual environment and is displayed on the terminal 300. In the robot system, one robot 100 is used to generate a character motion.

Alternatively, in a robot system according to another embodiment, different users may each possess a robot 100 and a terminal 300, and the robots 100 and the terminals 300 may be connected to the same server 200 so that characters created by the respective users are present in the same virtual environment. Hereinafter, an embodiment of the present disclosure will be described with respect to a case where a plurality of characters are present in the same virtual environment. A robot system and a control method thereof for a case where one character is present in a virtual environment can also be easily understood from the description presented below.

In a game illustrated in FIG. 2, a first character 1 and a second character 2 perform motions on the basis of robot motions inputted from respective robots 100.

Referring to FIG. 3, each character dances to music when music is played back by a terminal 300. In this case, first to third characters 1 to 3 perform their motions on the basis of robot motions inputted from respective robots 100 in real time. When the first to third characters 1 to 3 perform a group dance, the motions of the first to third characters 1 to 3 may be the same.

In addition to the cases illustrated in FIGS. 2 and 3, the robot system can be used to exhibit various motions of characters in diverse situations. Next, the characters illustrated in FIGS. 2 and 3 will be described in greater detail. For clarity, the case of FIG. 2 is referred to as a game scenario and the case of FIG. 3 is referred to as a dance scenario.

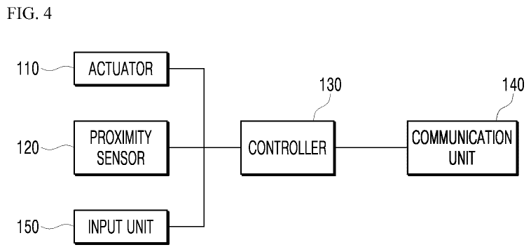

FIG. 4 is a diagram illustrating a structure of a robot 100 according to an embodiment of the present disclosure. The robot 100 may be similar in body shape to a human being. That is, the robot 100 is composed of a plurality of body parts and joints that join the body parts. The robot 100 includes actuators 110, proximity sensors 120, a controller 130, a communication unit 140, and an input unit 150.

The actuators 110 are disposed in the joints of the robot 100, and may operate to move each body part of the robot 100. The actuators 110 operate according to an operation command issued by the controller 130, and thereby rotate the joints such that the corresponding body part is moved. In this way, the robot 100 performs various motions.

A proximity sensor 120 is provided in each body part of the robot 100, and may detect when the body of a user is within a predetermined distance therefrom. The proximity sensor 120 may detect when the body of the user approaches and enters a region within a predetermined distance around the proximity sensor 120.

Examples of the proximity sensor 120 may include, as a sensing means, an ultrasonic sensor using ultrasonic waves, an optical sensor 151 using light, a capacitive sensor measuring and sensing the dielectric constant of a detection target, and other sensors using electric or magnetic fields.

The proximity sensor 120 may detect when the body of the user is in the vicinity of the robot 100, and transmit a sensor signal to the controller 130.

At least one proximity sensor 120 may be provided in each body part of the robot 100. Accordingly, when the user moves his or her finger to within close proximity of the robot 100, each of the proximity sensors 120 may detect the presence of the user's finger, and the actuator 110 operates according to the movement of the user's finger. In this way, the user may generate a motion of the robot 100 as he or she desires.

The controller 130 is connected with the actuators 110 and the proximity sensors 120, and controls operation of the actuators 110. That is, the controller 130 may receive a signal indicating that the body of the user is within a predetermined range from at least one of the proximity sensors 120, and command the actuators 110 to operate.

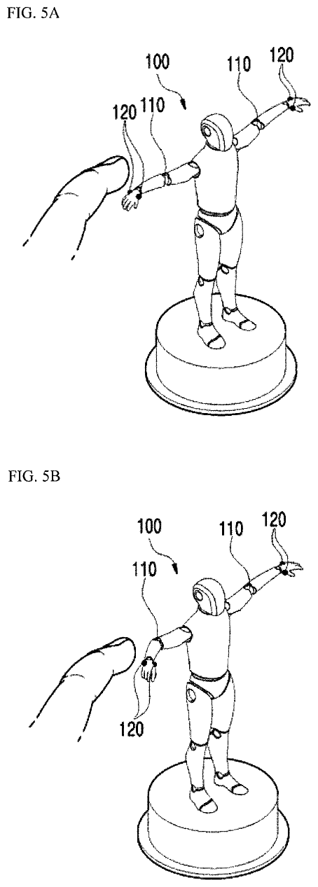

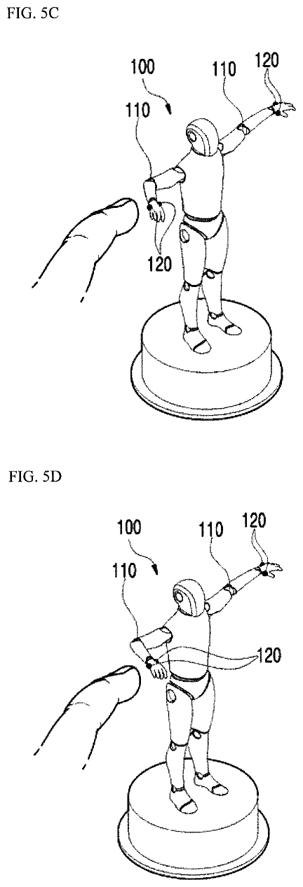

A process in which the actuators 110, the proximity sensor 120, and the controller 130 operate in conjunction with each other to generate a motion of the robot 100 will be described with reference to FIGS. 5A to 5D.

The communication unit 140 is connected with the controller 130, and the robot 100 is capable of communicating with the server 200 and the terminal 300 through the communication unit 140.

The communication unit 140 may be configured to include at least one of a mobile communication module or a wireless Internet module. In addition, the communication unit 140 may further include a short-range communication module.

The mobile communication module may perform wireless signal communication with at least one element selected from among a base station, the external terminal 300, and the server 200, over a mobile communication network that is constructed in accordance with technological standards for mobile communication and communication schemes (for example, global system for mobile communication (GSMC), code division multi access (CDMA), code division multi access 2000 (CDMA), enhanced voice-data optimized or enhanced voice-data only (EV-DO), wideband CDMA (WCDMA), high speed downlink packet access (HSPDA), high speed uplink packet access (HSUPA), long term evolution (LED), long term evolution-advanced (LET-A), and 5G mobile communication).

The wireless Internet module refers to a module for wireless Internet access. The wireless Internet module may be built in the robot 100 or may be provided as a separate device. The wireless Internet module is configured to transmit and receive wireless signals over a communication network that is based on wireless Internet technologies.

The robot 100 may transmit and receive data to and from the server 200 and various terminals 300 capable of performing communication. In particular, the robot 100 may perform data communication via a 5G network with the server 200 and the terminal 300, using at least one network service among enhanced mobile broadband (eMBB), ultra-reliable and low latency communications (URLLC), and massive machine-type communications (mMTC).

Enhanced Mobile Broadband (eMBB) is a mobile broadband service, and provides, for example, multimedia contents and wireless data access. In addition, improved mobile services such as hotspots and broadband coverage for accommodating the rapidly growing mobile traffic may be provided via eMBB. Through a hotspot, the high-volume traffic may be accommodated in an area where user mobility is low and user density is high. Through broadband coverage, a wide-range and stable wireless environment and user mobility may be guaranteed.

The Ultra-reliable and low latency communications (URLLC) service defines requirements that are far more stringent than existing LTE in terms of reliability and delay of data transmission. Examples of URLLC services include 5G services for production process automation, telemedicine, remote surgery, transportation, and safety.

The Massive machine-type communications (mMTC) is a transmission delay-insensitive service that requires a relatively small amount of data transmission. The mMTC enables a much larger number of terminals 300, such as sensors, than general mobile cellular phones to be simultaneously connected to a wireless access network. The communication module of the terminal 300 should be inexpensive, and there is a need for improved power efficiency and power saving technology capable of operating for years without battery replacement or recharging.

FIGS. 5A to 5D are diagrams illustrating a motion of a robot 100 according to an embodiment of the present disclosure. In a case where a user generates a motion of the robot 100 with his or her finger, when the user's finger comes into contact with a portion of the robot 100, the proximity sensor 120 detects that the user's finger is within a preset detection range.

The proximity sensor 120 that has detected the user's finger transmits a sensor signal to the controller 130. The controller 130 operates the actuators 110 when receiving the sensor signal, and the actuators 110 generates a motion of the robot 100 by changing the pose of the robot 100.

The proximity sensors 120 can detect the presence of the user's finger without being in contact with the user's finger. The actuators 110 may continuously operate during a state in which the user's finger is detected by the proximity sensor 120.

Therefore, when the user's finger moves while maintaining a predetermined distance range from the proximity sensor 120, the actuators 110 may move to follow the user's finger.

That is, as illustrated in FIGS. 5A through 5D, when the user's finger continuously moves to thereby change the pose of the robot 100 from 5A to 5B, to 5C, and finally to 5D, a motion of the robot 100 may be generated.

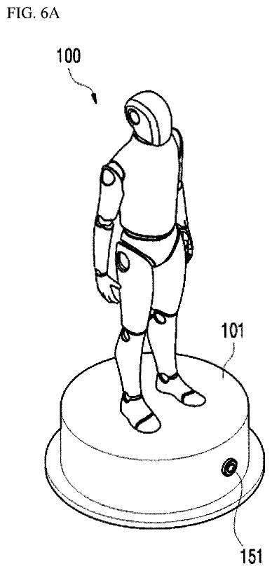

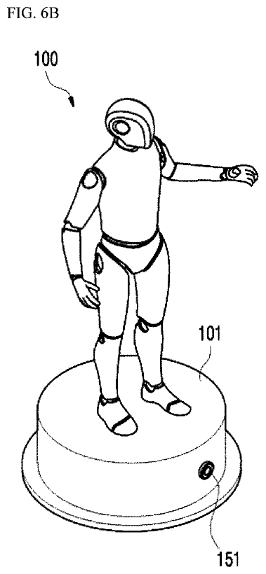

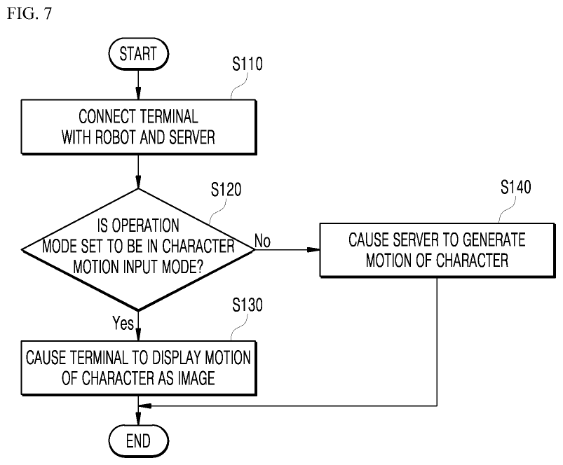

FIGS. 6A to 6B are diagrams illustrating a motion of a robot 100 according to another embodiment of the present disclosure. The robot 100 includes an input unit 150. The user may generate a motion of the robot 100 using the input unit 150.

The input unit 150 is provided in the robot 100, and may receive input of a signal representing the motion of the robot 100. The robot 100 may perform a motion corresponding to the signal inputted to the input unit 150 of the robot 100.

The controller 130 is connected with the input unit 150. The controller 130 may receive the signal from the input unit 150 and thereby operate the actuators 110. The actuators 110 may generate a robot motion corresponding to the input signal. The motion of the robot 100, which is generated according to the inputted signal, may be a preset motion.

The input unit 150 may be provided with at least one of an optical sensor 151 or an acceleration sensor. Referring to FIG. 6, the optical sensor 151 and the acceleration sensor may be provided in a support 101, of which the form does not change, that supports the robot 100. In the example of FIG. 6, since the acceleration sensor is embedded in the support 101, the acceleration sensor is not shown in FIG. 6.

For example, when the input unit 150 is provided with the optical sensor 151, the user may cause a motion of the robot 100 by moving his or her finger in the vicinity of the optical sensor 151. The optical sensor 151 detects the movement of the user's finger, and the actuators 110 generate a motion of the robot 100 by moving each part of the robot 100 according to a sensor signal outputted from the optical sensor 151.

For example, in a case where a setting is made such that the robot 100 performs a walking motion when the movement of the user's finger is detected by the optical sensor 151, the actuators 110 continuously operate to move the arms of the robot 100 forwards and backwards, as illustrated in FIG. 6B, when the movement of the user finger is detected. In this case, the setting may be made such that the walking motion is stopped when the movement of the user's finger is detected again by the optical sensor 151.

For example, when the input unit 150 is provided with the acceleration sensor, a motion of the robot 100 may be generated by pulling or pushing the robot 100 such that the position of the robot 100 is changed. The acceleration sensor may detect a position change of the robot 100, and the actuators 110 may generate a motion of the robot 100 according to the detected position change.

For example, in a case where a setting is made such that the robot 100 performs a running motion when the position change of the robot 100 is detected by the acceleration sensor, the actuators 110 continuously operate such that the robot 100 performs a running motion when the position change of the robot 100 is detected. The setting may be made such that the running motion is stopped when the user pushes or pulls the robot 100 again.

As in the case of using the proximity sensor 120, a motion of the robot 100, which is generated with the use of the input unit 150, may be represented as a motion of a character.

Although in the example described above the robot 100 is manipulated to generate a robot motion, the robot 100 may also perform the same or a similar motion to that of a character displayed on the terminal 300, by receiving an operation command from the terminal 300.

For example, the server 200 may transmit motion information of a character to the terminal 300, and the terminal 300 may display a motion of the character on the basis of the received motion information. In addition, the terminal 300 may transmit the motion information of the character to the controller 130 of the robot 100, and the controller 130 may operate the actuators 110 according to the received information such that the robot 100 performs the same motion as or a similar motion to that of the character.

An operation of the robot system may be switched between a character motion input mode and a character motion playback mode. The robot system may generate a motion of a character during the character motion input mode, and display the motion of the character on the terminal 300 during the character motion playback mode.

In the character motion input mode, the user may input a motion of a character by moving the robot 100. In the character motion input mode, a plurality of motions of the robot 100 may be generated and transmitted to the terminal 300. To this end, the user may move a body part and/or joint of the robot 100, and the actuators 110 may accordingly operate such that the robot 100 performs a predetermined motion. A plurality of motions of the robot 100 may be generated sequentially.

The terminal 300 may transmit the motions of the robot 100 to the server 200. The server 200 may generate motions of a character on the basis of the motions of the robot 100.

Since the motions of the robot 100 which are inputted to the server 200 are generated by using the robot 100, of which the movements are limited, it may be difficult to generate the motions of the character desired by the user if the motions of the robot 100 are translated into the motions of the character as they are. In addition, the motions of the robot 100 that are sequentially inputted to the server 200 may be discontinuous. Therefore, it is necessary to combine the plurality of motions that are inputted to generate a natural continuous character motion.

The server 200 may combine the plurality of motions of the robot 100 transmitted from the terminal 300 to generate character motions which are more diverse and continuous than those of the robot 100. That is, there may be a considerable difference between the motions of the character and the motions of the robot 100, and the differences may be managed by the server 200.

The server 200 may perform artificial intelligence (AI) model learning to generate motions of the character different from the motions of the robot 100. The server 200 may be provided with an AI module for executing the AI model learning.

The artificial intelligence (AI) is one field of computer science and information technology that studies methods to make computers mimic intelligent human behaviors such as reasoning, learning, self-improving and the like.

The AI module may derive a motion of a character from a motion of a robot 100 through the AI model learning. When a series of motions of the robot 100 is inputted to the AI module, the AI module may derive a character motion from the series of motions of the robot 100 through AI model learning.

Examples of the AI model include a decision tree, a Bayesian network, a support vector machine (SVM), and an artificial neural network (ANN).

ANNs may include, but are not limited to, network models such as a deep neural network (DNN), a recurrent neural network (RNN), a bidirectional recurrent deep neural network (BRDNN), a multilayer perception (MLP), and a convolutional neural network (CNN).

For example, when performing learning using the RNN, among the AI models, the generated motions of the robot 100, which are input parameters, may be sequentially inputted to the ANN, and the plurality of motions of the robot 100 may be combined and calculated in the ANN so as to derive character motions corresponding to the robot motions. The character motions are slight modifications to the motions of the robot 100. More complex and continuous character motions are obtained than the motions of the robot 100.

The server 200 may generate the character motions through AI model learning, and the generated character motions may be stored in the server 200. The character motions stored in the server 200 may be displayed on the terminal 300 during the character motion playback mode.

In the character motion playback mode, the generated character motions may be generated on the terminal 300. In the character motion playback mode, the server 200 may transmit the character motions to the terminal 300, and the terminal 300 may display the character motions as an image. The character motions may be motions stored in the server 200 during the character motion input mode.

Referring to FIG. 2, in a game scenario, first and second characters 1 and 2 perform attack and defense motions in the character motion playback mode. The motions of the first and second characters 1 and 2 may be generated by transmitting the motions of each of two robots 100 to the server 200, and performing AI model learning based on the robot motions in the server 200.

Referring to FIG. 3, in a dancing scenario, first, second, and third characters 1 to 3 perform dancing motions which are partially the same or different from each other in the character motion playback mode. The motions of the first, second, and third characters 1 to 3 may be generated by transmitting the motions of each of three robots 100 to the server 200, and performing AI model learning based on the robot motions in the server 200.

Referring to FIGS. 2 and 3, the motions of the respective characters displayed on the terminal 300 are the same as or partially different from each other. All of the motions of the plurality of characters are generated through AI model learning in the server 200.

However, during the character motion playback mode, there may be case where it is necessary to modify the motion of a character with the real-time intervention of the user. Specifically, in a game scenario in order to proceed with the game, it is necessary for the user to frequently modify the motion of a character during the playback of the character motions.

In a dance scenario, there may be a case where the user wants to change the dancing motion of a character in real time to match music being played by the terminal 300. Therefore, it is necessary to allow the user to modify the motion of the character.

The robot system is configured to allow the user to modify the motion of a character at any time, on the basis of the motion of the corresponding robot 100 in the character motion playback mode. In the character motion playback mode, the user is able to generate a motion of the robot 100 by moving the robot 100. The robot 100 may transmit the motion of the robot 100 to the terminal 300, and the terminal 300 may transmit the motion of the robot 100 to the server 200.

The server 200 may modify the motion of the character on the basis of the motion of the robot 100 and transmit the modified motion of the character to the terminal 300, and the terminal 300 may display the modified motion of the character as an image.

The modified motion is generated by the server 200 during the character motion input mode, and is then stored in the server 200. When the server 200 receives the motion of a robot 100 during the character motion playback mode, the server 200 searches for a character motion corresponding to the motion of the robot 100 from among the stored character motions and transmits the retrieved character motion to the terminal 300 as the modified character motion, and the terminal 300 displays the modified character motion thereon.

As described above, the robot system may include a plurality of robots 100 and a plurality of characters. The server 200 may receive motions of each of the plurality of robots 100, and accordingly may generate a modified motion for each corresponding character.

Here, the server 200 may combine the motions transmitted from the each of the plurality of robots 100, and thereby generate motions for all of the plurality of characters existing in the same virtual space.

Referring to FIGS. 2 and 3, the modified motions of the characters displayed on the terminal 300 may be the same as or partially different from each other, and may thus be in overall harmony with each other. The overall performance composed of the motions of the plurality of characters may be generated through the AI model learning by the server 200, as described above.

The modified motions generated by the server 200 may be stored in the server 200. The character motions stored in the server 200 may be used to produce a performance to be displayed during the character motion playback mode. That is, the server 200 may store the character motions generated both during the character motion input mode and the character motion playback mode, and the character motions can be used during the character motion playback mode.

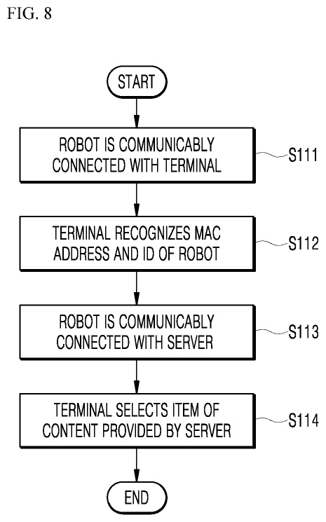

FIG. 7 is a diagram illustrating a method of controlling a robot system according to an embodiment of the present disclosure. In describing the control method below, description of the same constituent elements or operations as those described above will be omitted.

For control of a robot system, a terminal 300 may be connected with a robot 100 and a server 200 in step S110.

After the connection is completed, whether the robot system is in the character motion input mode may be checked in step S120. The checking may be performed by the terminal 300 or the server 200. For example, the terminal 300 may receive a mode selection input from the user, and the terminal 300 and the server 200 connected with the terminal 300 may check whether the robot system is in the character motion input mode or the character motion playback mode according to the mode selection input.

When the robot system is in the character motion input mode, the server 200 may generate motions of characters in step S130. When the robot system is in the character motion playback mode, the terminal 300 may display the character motions as an image in step S140. Hereinafter, steps S110, S130, and S140 will be described in greater detail.

FIG. 8 is a diagram illustrating a process in which the terminal 300 is connected with the robot 100 and the server 200.

In step S110, the robot 100 may be communicably connected with the terminal 300 (step S111). A communication unit 140 of the robot 100 and the terminal 300 may be communicably connected with each other.

The terminal 300 may recognize a MAC address and an identifier of the robot 100 (step S112). That is, the connection of the terminal 300 with the robot 100 has been completed, and the terminal 300 recognizes the MAC address and the identifier of the robot 100 so as to determine operational characteristics of the robot 100. Thus, information on motions of the robot 100 may be transmitted to the terminal 300.

The terminal 300 may be communicably connected with the server 200 (step S113). Since the terminal 300 is connected with each of the robot 100 and the server 200, the robot 100 may be connected with the server 200.

The terminal 300 may select one item of content among the contents provided by the server 200 (step S114). The user selects the item of content provided by the server 200 from a menu screen on the terminal 300. That is, one item of content among the contents provided by the server 200 is selected from the terminal 300. The contents provided by the server include a game scenario illustrated in FIG. 2, a dance scenario illustrated in FIG. 3, and various other scenarios.

The robot system may perform various tasks, such as generating a motion of a character and playing music, according to the selected content.

In addition, the robot 100 may be directly connected with the server 200 so as to receive updates from the server 200. The connection between the robot 100 and the server 200 may be performed in a similar manner to the connection between the robot 100 and the terminal 300.

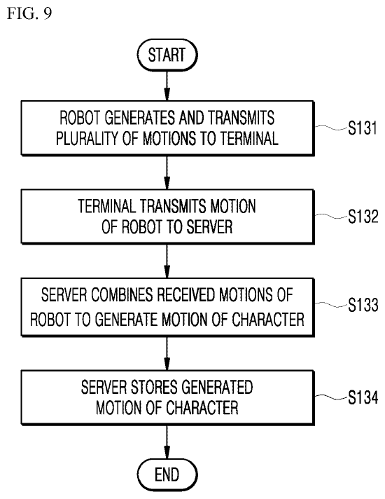

FIG. 9 is a diagram illustrating a process in which the server 200 generates a motion of a character (S130), according an embodiment of the present disclosure.

In step S130, robot 100 may generate a plurality of motions, and transmit the plurality of motions to the terminal 300 (step S131). The user may move the robot 100 to generate the motions of the robot 100, and a plurality of the motions may be generated sequentially.

The terminal 300 may transmit the motions of the robot 100 to the server 200 (step S132).

The server 200 combines the received robot motions to generate a character motion (step S133). The character motions generated by the server 200 may be more diverse and more continuous than those of the robots.

As described above, the server 200 may perform artificial intelligence (AI) model learning to generate character motions that are different from the motions of the robot 100.

The server 200 may store the generated motions of the character (step S134). The character motions stored in the server 200 may be displayed on the terminal 300 during the character motion playback mode.

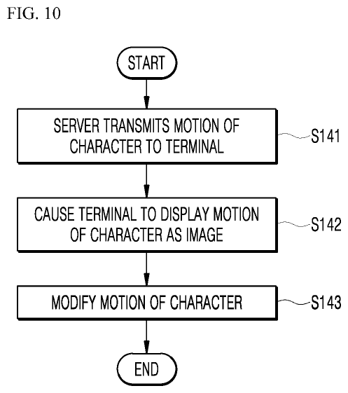

FIG. 10 is a diagram illustrating a process in which the terminal 300 displays an image showing a motion of a character, according to an embodiment of the present disclosure.

In step S140, the server 200 may transmit the character motions to the terminal 300 (step S141). The terminal 300 displays the character motions as an image (step S142). In a state in which the character motions are being displayed, the character motions may be modified (step S143).

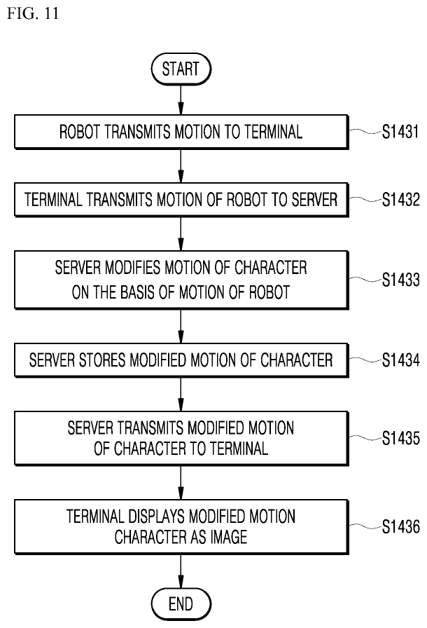

FIG. 11 is a diagram illustrating a process of modifying a motion of a character, according to an embodiment of the present disclosure.

In step S143, the robot 100 may transmit motions thereof to the terminal 300 (step S1431). The motions of the robot 100 are generated by the user in a state in which the motions of the character are being displayed.

The terminal 300 may transmit the motions of the robot 100 to the server 200 (step S1432).

The server 200 may modify the motions of the character on the basis of the motions of the robot 100 (step S1433). The modified motion is generated by the server 200 during the character motion input mode, and is then stored in the server 200. When the server 200 receives a certain robot motion while in the character motion playback mode, the server 200 may search for a character motion corresponding to the robot motion from among the character motions stored in the server 200, and modify the retrieved character motion.

The server 200 may store the generated modified character motion (step S1434). The character motions stored in the server 200 may be used to produce a performance to be displayed during the character motion playback mode. That is, the server 200 may store the character motions generated both during the character motion input mode and the character motion playback mode, and the character motions can be used during the character motion playback mode.

The server 200 may transmit the modified character motions to the terminal 300 (step S1435).

The terminal 300 may display the character motions as an image (step S1436).

According to embodiments of the present disclosure, the user may input a motion by using a three-dimensional robot. Accordingly the level of immersion in a game or display content may be improved.

According to the embodiments of the present disclosure, the user may use a robot 100 equipped with proximity sensors 120. Therefore, the user may conveniently generate a motion of a character.

According to the embodiments of the present disclosure since the server 200 may generate character motions on the basis of the robot motions using artificial intelligence model learning, diverse and complex character motions may be generated.

An AI device, an AI server, and an AI system according to an embodiment of the present disclosure will be described below.

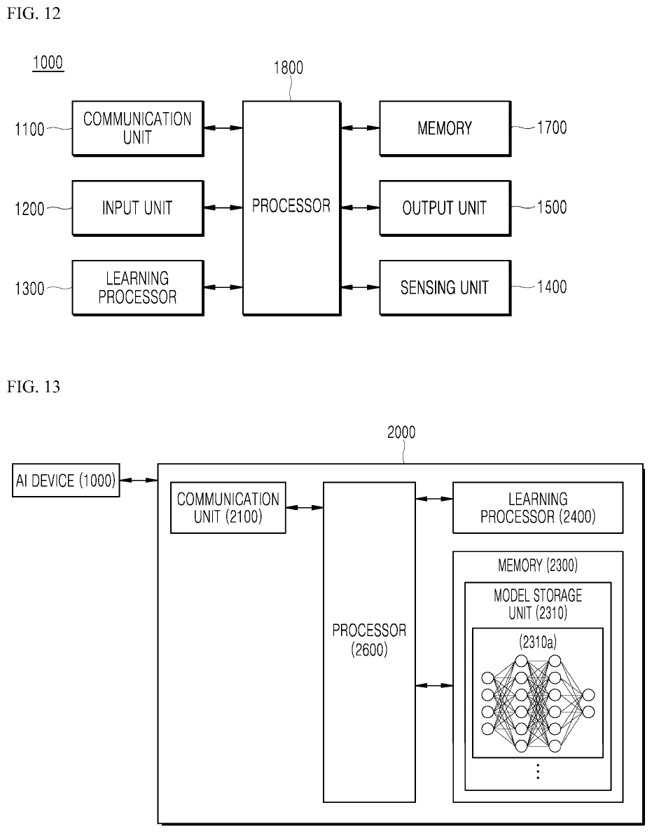

FIG. 12 is a diagram illustrating an artificial intelligence (AI) device 1000 according to an embodiment of the present disclosure.

The AI device 1000 may be implemented as a mobile or immobile device such as a TV, a projector, a mobile phone, a smartphone, a desktop computer, a notebook computer, a digital broadcast terminal, a personal digital assistant (PDA), a portable multimedia player (PMP), a navigation device, a tablet PC, a wearable device, a set-top box (STB), a digital media broadcasting (DMB) receiver, a radio, a washing machine, a refrigerator, a desktop computer, digital signage, a robot, and a vehicle.

Referring to FIG. 12, the AI device 1000 may include a communication unit 1100, an input unit 1200, a learning processor 1300, a sensing unit 1400, an output unit 1500, a memory 1700, and a processor 1800.

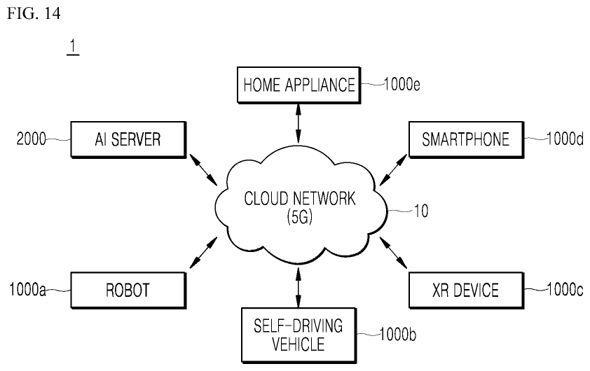

The communication unit 1100 may transmit or receive data with external devices, such as other AI devices (1000a to 1000e in FIG. 14) or an AI server (2000 in FIGS. 13 and 14) using wired/wireless communications technology. For example, the communication unit 1100 may transmit or receive sensor data, a user input, a trained model, a control signal, and the like with the external devices.

In this case, the communications technology used by the communication unit 1100 may be technology such as global system for mobile communication (GSM), code division multi access (CDMA), long term evolution (LTE), 5G, wireless LAN (WLAN), Wireless-Fidelity (Wi-Fi), Bluetooth™, radio frequency identification (RFID), infrared data association (IrDA), ZigBee, and near field communication (NFC).

The input unit 1200 may obtain various types of data.

The input unit 1200 may include a camera for inputting an image signal, a microphone for receiving an audio signal, and a user input unit for receiving information inputted by a user. Here, the camera or the microphone may be treated as a sensor, and the signal obtained from the camera or the microphone may be referred to as sensing data or sensor information.

The input unit 1200 may acquire various kinds of data, such as learning data for model learning and input data used when an output is acquired using a trained model. The input unit 1200 may obtain raw input data. In this case, the processor 1800 or the learning processor 1300 may extract an input feature by preprocessing the input data.

The learning processor 1300 may train a model, composed of an artificial neural network using learning data. Here, the trained artificial neural network may be referred to as a trained model. The trained model may be used to infer a result value with respect to new input data rather than learning data, and the inferred value may be used as a basis for a determination to perform an operation.

The learning processor 1300 may perform AI processing together with a learning processor 2400 of the AI server 2000.

The learning processor 1300 may include a memory which is combined or implemented in the AI device 1000. Alternatively, the learning processor 1300 may be implemented using the memory 1700, an external memory directly coupled to the AI device 1000, or a memory maintained in an external device.

The sensing unit 1400 may obtain at least one of internal information of the AI device 1000, surrounding environment information of the AI device 1000, or user information, by using various sensors.

The sensing unit 1400 may include sensors such as a proximity sensor, an illumination sensor, an acceleration sensor, a magnetic sensor, a gyroscope sensor, an inertial sensor, an RGB sensor, an infrared (IR) sensor, a fingerprint recognition sensor, an ultrasonic sensor, an optical sensor, a microphone, a light detection and ranging (lidar) sensor, and a radar.

The output unit 1500 may generate a visual, auditory, or tactile related output.

The output unit 1500 may include a display unit outputting visual information, a speaker outputting auditory information, and a haptic module outputting tactile information.

The memory 1700 may store data to support various functions of the AI device 1000. For example, the memory 1700 may store input data, training data, a trained model, and training history, acquired by the input unit 1200.

The processor 1800 may determine at least one executable operation of the AI device 1000 based on information determined or generated by using a data analysis algorithm or a machine learning algorithm. In addition, the processor 1800 may control components of the AI device 1000 to thereby perform the determined operation.

In order to do so, the processor 1800 may request, retrieve, receive, or use information or data of the learning processor 1300 or the memory 1700, and may control components of the AI device 1000 to thereby execute a predicted operation, or an operation determined to be preferable, among the determined at least one executable operation.

In this case, when connection with an external device is necessary in order to perform the determined operation, the processor 1800 may generate a control signal for controlling the corresponding external device, and may transmit the generated control signal to the corresponding external device.

The processor 1800 may obtain intent information about a user input, and determine a requirement of a user based on the obtained intent information.

The processor 1800 may obtain intent information corresponding to the user input by using at least one of a speech-to-text (STT) engine for converting a speech input into a character string or a natural language processing (NLP) engine for obtaining intent information from natural language.

The at least one of the STT engine or the NLP engine may be composed of artificial neural networks, at least some of which are trained according to a machine learning algorithm. In addition, the at least one of the STT engine or the NLP engine may be trained by the learning processor 1300, trained by the learning processor 2400 of the AI server 2000, or trained by distributed processing thereof.

The processor 1800 may collect history information including, for example, operation contents and user feedback on an operation of the AI device 1000, and may store the history information in the memory 1700 or the learning processor 1300, or transmit the history information to an external device such as the AI server 2000. The collected history information may be used to update a learning model.

The processor 1800 may control at least some of components of the apparatus 1000, in order to drive an application stored in the memory 1700. Furthermore, the processor 1800 may combine and operate at least two or more constituting elements among the constituting elements included in the AI device 1000, in order to operate the application program.

FIG. 13 is a diagram illustrating an artificial intelligence (AI) server 2000 according to an embodiment of the present disclosure.

Referring to FIG. 13, the AI server 2000 may refer to a device for training an artificial neural network using a machine learning algorithm or using a trained artificial neural network. Here, the AI server 2000 may include a plurality of servers to perform distributed processing, and may be defined as a 5G network. In this case, the AI server 2000 may be included as a part of the AI device 1000, and may thus perform at least a part of the AI processing together with the AI device 1000.

The AI server 2000 may include a communication unit 2100, a memory 2300, a learning processor 2400, and a processor 2600.

The communication unit 2100 may transmit and receive data with an external device such as the AI device 1000.

The memory 2300 may include a model storage unit 2310. The model storage unit 2310 may store a model (or an artificial neural network 2310a) which has been learned or is being learned via the learning processor 2400.

The learning processor 2400 may train the artificial neural network 2310a by using learning data. The learning model may be used while mounted in the AI server 2000 of the artificial neural network, or may be used while mounted in an external device such as the AI device 1000.

The learning model may be implemented as hardware, software, or a combination of hardware and software. When a portion or the entirety of the learning model is implemented as software, one or more instructions, which constitute the learning model, may be stored in the memory 2300.

The processor 2600 may infer a result value with respect to new input data by using the learning model, and generate a response or control command based on the inferred result value.

FIG. 14 is a diagram illustrating an AI system 1 according to an embodiment of the present disclosure.

Referring to FIG. 14, in the AI system 1, at least one of an AI server 2000, a robot 1000a, a self-driving vehicle 1000b, an XR device 1000c, a smartphone 1000d, or a home appliance 1000e are connected to a cloud network 10. Here, the robot 1000a, the self-driving vehicle 1000b, the XR device 1000c, the smartphone 1000d, or the home appliance 1000e, to which AI technology has been applied, may be referred to as an AI device 1000a to 1000e.

A cloud network 10 may comprise part of a cloud computing infrastructure, or refer to a network existing in cloud computing infrastructure. Here, the cloud network 10 may be constructed by using a 3G network, a 4G or Long Term Evolution (LTE) network, or a 5G network.

In other words, the devices 1000a to 1000e and 2000 constituting the AI system 1 may be connected to each other through the cloud network 10. In particular, each individual device 1000a to 1000e and 2000 may communicate with each other through a base station, but may also communicate directly to each other without relying on the base station.

The AI server 2000 may include a server performing AI processing and a server performing computations on big data.

The AI server 2000 may be connected to at least one of the robot 1000a, the self-driving vehicle 1000b, the XR device 1000c, the smartphone 1000d, or the home appliance 1000e, which are AI devices constituting the AI system 1, through the cloud network 10, and may assist with at least a part of the AI processing conducted in the connected AI devices 1000a to 1000e.

At this time, the AI server 2000 may train the artificial neural network according to a machine learning algorithm instead of the AI devices 1000a to 1000e, and may store the learning model or transmit the learning model to the AI devices 1000a to 1000e.

At this time, the AI server 2000 may receive input data from the AI devices 1000a to 1000e, infer a result value from the received input data by using the learning model, generate a response or control command based on the inferred result value, and transmit the generated response or control command to the AI devices 1000a to 1000e.

In addition, the AI devices 1000a to 1000e may infer a result value from the input data directly by employing the learning model, and generate a response or control command based on the inferred result value.

Although embodiments of the present disclosure have been described, the present disclosure is not limited to the described embodiments. Instead, the technical features of the embodiments previously described, unless incompatible with each other, may be combined in various ways to provide other embodiments.

1. A robot system, comprising:
a robot;
a sever storing information on a motion of the robot; and
a terminal configured to communicate with the robot and the server, receive the motion of the robot from the robot, and display a character corresponding to the robot as an image,
wherein the robot comprises:
at least one actuator operating to move each of parts of the robot;
proximity sensors provided in the respective parts of the robot, and each configured to detect a part of a user when the part of the user is present within a predetermined range around the corresponding proximity sensor;
a controller connected with the actuators and the proximity sensors, and configured to control the actuators to operate based on the detections of the proximity sensors; and
a communication unit connected with the controller.

2. The robot system according to claim 1, wherein in a character motion input mode, the robot generates a plurality of motions and transmits the motions to the terminal, the terminal transmits the motions of the robot to the server, and the server combines the motions of the robot that are transmitted from the robot so as to generate a motion of the character.

3. The robot system according to claim 2, wherein the generated motion of the character is stored in the server.

4. The robot system according to claim 2, wherein, in a character motion playback mode, the server transmits the motion of the character to the terminal, and the terminal displays the motion of the character as an image.

5. The robot system according to claim 1, wherein, in a character motion playback mode,
the robot transmits the motion of the robot to the terminal;
the terminal transmits the motion of the robot to the server;
the server generates and modifies the a motion of the character based on the motion of the robot, and transmits the modified motion of the character to the terminal; and
the terminal displays the modified motion of the character as an image.

6. The robot system according to claim 5, wherein a plurality of robots and a plurality of characters are included in the robot system, and the server generates a motion of each of the plurality of characters present in a same virtual space by combining motions transmitted from each of the plurality of robots.

7. The robot system according to claim 5, wherein the modified motion of the character is stored in the server.

8. The robot system according to claim 1, wherein the robot comprises an input unit configured to receive an input associated with the motion of the robot,
wherein the robot generates a motion corresponding to an input signal corresponding to the input received by the input unit.

9. The robot system according to claim 8, wherein the controller is operatively connected with the input unit, and operates the actuators according to the input signal, and
the controller controls the actuators to generate the motion of the robot in accordance with the input signal.

10. The robot system according to claim 8, wherein the input unit comprises at least one sensor among an optical sensor and an acceleration sensor.

11. A method of controlling a robot system including a robot, a terminal and a server, the method comprising:
connecting the terminal with the robot and the server;
determining whether the robot system is in a character motion input mode or in a character motion playback mode;
generating, by the server, a motion of a character when it is determined that the robot system is in the character motion input mode; and
displaying, by the terminal, the motion of the character as an image when it is determined that the robot system is in the character motion playback mode,
wherein the robot includes:
at least one actuator that operates to move each part of the robot,
proximity sensors provided in the respective parts of the robot and each configured to detect a part of a user when the part of the user is present within a predetermined range around the corresponding proximity sensor,
a controller connected with the actuators and the proximity sensors, and configured to control the actuators to operate based on the detections of the proximity sensors, and
a communication unit connected with the controller.

12. The method according to claim 11, wherein the connecting of the terminal with the robot and the server comprises:
connecting the robot with the terminal so that the robot is capable of communicating with the terminal;
determining, by the terminal, a MAC address and an identifier of the robot;
connecting the terminal with the server so that the robot is capable of communicating with the server; and
selecting, by the terminal, an item of content provided by the server.

13. The method according to claim 11, wherein the generating of the motion of the character comprises:
generating, by the robot, a plurality of motions, and transmitting the plurality of motions to the terminal;
transmitting, by the terminal, the plurality of motions of the robot to the server;
combining, by the server, the received motions of the robot so as to generate a motion of the character; and
storing, by the server, the generated motion of the character.

14. The method according to claim 11, wherein the displaying of the motion of the character comprises:
transmitting, by the server, the motion of the character to the terminal; and
displaying, on a display of the terminal, the motion of the character as an image.

15. The method according to claim 14, wherein the displaying of the motion of the character further comprises:
transmitting, by the robot, the motion of the robot to the terminal;
transmitting, by the terminal, the motion of the robot to the server;
modifying, by the server, the motion of the character based on the motion of the robot;
storing, by the server, the modified motion of the character;
transmitting, by the server, the modified motion of the character to the terminal; and
displaying, by the terminal, the modified motion of the character as an image.

16. The robot system according to claim 1, wherein the parts of the robot correspond to body parts of a human.

17. A robot for communicating with a terminal, the robot comprising:
a robot body including parts corresponding to parts of a human body;
a proximity sensor configured to detect a movement of a body part of a user when the boy part of the user is present within a predetermined non-contact range of the proximity sensor;
at least one actuator configured to move one of the parts of the robot;
a controller configured to control the at least one actuator to move the one of the parts of the robot based on the detection of the proximity sensor; and
a communication unit configured to transmit information on the movement of the one of the parts of the robot to the terminal for displaying a character corresponding the movement of the one of the parts of the robot.

18. The robot according to claim 17, further comprising:
an input unit configured to receive an input associated with a movement of the robot, and generate an input signal based on the received input,
wherein the controller controls the at least one actuator to move the robot according to the input signal of the input unit.

19. The robot according to claim 17, wherein the communication unit is further configured to communicate with a server in communication with the terminal, so that when the robot is in a character motion input mode, the controller generates a plurality of motions and transmits the motions to the server via the terminal, and the server combines the motions of the robot that are transmitted from the robot so as to generate a motion of the character.

20. The robot according to claim 19, wherein when the robot is in a character motion playback mode, the motion of the character generated by the server based on the motions of the robot is displayed as an image on a display of the terminal.
